(19) United States
(12) Patent Application Publication
(10) Pub. No.: US 2025/0210250 A1
(43) Pub. Date: Jun. 26, 2025

(54) COIL COMPONENT

(71) Applicant: Murata Manufacturing Co., Ltd., Kyoto-fu (JP)

(72) Inventors: Kenji NARA, Nagaokakyo-shi (JP); Tatsuya SASAKI, Nagaokakyo-shi (JP); Naoki WATANABE, Nagaokakyo-shi (JP); Shin HASEGAWA, Nagaokakyo-shi (JP); Yuuji IGARASHI, Nagaokakyo-shi (JP)

(73) Assignee: Murata Manufacturing Co., Ltd., Kyoto-fu (JP)

(21) Appl. No.: 19/077,188

(22) Filed: Mar. 12, 2025

Related U.S. Application Data
(63) Continuation of application No. PCT/JP2024/000566, filed on Jan. 12, 2024.

(30) Foreign Application Priority Data
Mar. 1, 2023 (JP) 2023-031131

(51) Int. Cl. H01F 27/30; H01F 17/06; H01F 27/29

(52) U.S. Cl. CPC H01F 27/30; H01F 17/062; H01F 27/29

(57) ABSTRACT

A coil component includes a core having an annular shape, a coil wound around the core, an electrode terminal connected to the coil, and an attachment base portion to which the electrode terminal is attached. The attachment base portion includes an inner end face facing a core side, an outer end face facing a side opposite to the inner end face, a bottom surface coupling the inner end face and the outer end face to each other, and a top surface facing a side opposite to the bottom surface, and the attachment base portion includes a slit hole penetrating between the inner end face and the outer end face. The electrode terminal includes first and second flat plate portions, and a coupling portion coupling the first and second flat plate portions to each other, and the first flat plate portion and the second flat plate portion face each other.

### CROSS-REFERENCE TO RELATED APPLICATIONS

This application claims benefit of priority to International Patent Application No. PCT/JP2024/000566, filed Jan. 12, 2024, and to Japanese Patent Application No. 2023-031131, filed Mar. 1, 2023, the entire contents of each are incorporated herein by reference.

### BACKGROUND

### Technical Field

The present disclosure relates to a coil component.

### Background Art

In the related art, a coil component is described in WO2017/169737. This coil component includes an annular core, a coil wound around the core, an electrode terminal connected to the coil, and a case that covers the core and the coil. The electrode terminal is attached to a bottom surface of a bottom plate portion of the case. That is, the bottom plate portion includes an attachment base portion to which the electrode terminal is attached.

### SUMMARY

Meanwhile, in the coil component of the related art, the electrode terminal is fixed to the bottom surface of the bottom plate portion of the case, for example, using an adhesive member. Therefore, when the coil component is mounted on a mounting substrate, vibrations or impacts applied to the coil component may cause the electrode terminal to be detached from the bottom plate portion (attachment base portion). In particular, as the current increases and the core becomes larger, resulting in a greater weight for the coil component, vibrations or impacts become more significant, making the detachment of the electrode terminal from the bottom plate portion (attachment base portion) more pronounced.

In this regard, the present disclosure provides a coil component capable of reducing detachment of an electrode terminal from an attachment base portion.

Accordingly, a coil component of one aspect of the present disclosure includes a core having an annular shape; a coil wound around the core; an electrode terminal connected to the coil; and an attachment base portion to which the electrode terminal is attached. The attachment base portion includes an inner end face facing a core side, an outer end face facing a side opposite to the inner end face, a bottom surface coupling the inner end face and the outer end face to each other, and a top surface facing a side opposite to the bottom surface, and the attachment base portion includes a slit hole penetrating between the inner end face and the outer end face. The electrode terminal includes a first flat plate portion, a second flat plate portion, and a coupling portion coupling the first flat plate portion and the second flat plate portion to each other, and the first flat plate portion and the second flat plate portion face each other. The first flat plate portion is inserted into the slit hole, the coupling portion faces the outer end face, the second flat plate portion faces the bottom surface, and the first flat plate portion is connected to an end portion of the coil.

Here, the bottom surface is a surface facing a mounting substrate side when the coil component is mounted on the mounting substrate.

According to the above-described aspect, since the first flat plate portion of the electrode terminal is inserted into the slit hole of the attachment base portion, the electrode terminal is inserted into and attached to the attachment base portion. Consequently, the electrode terminal can be reliably fixed to the attachment base portion, and when the coil component is mounted on the mounting substrate, the detachment of the electrode terminal from the attachment base portion can be reduced even in a case where vibrations or impacts are applied to the coil component. In particular, even as the current increases, the core becomes larger, the weight of the coil component becomes greater, and vibrations or impacts become more significant, the detachment of the electrode terminal from the attachment base portion can be reduced.

Preferably, in one embodiment of the coil component, the core is an oval annular body as viewed in a central axis direction, the attachment base portion includes a first attachment base portion and a second attachment base portion, and the first attachment base portion and the second attachment base portion are positioned on respective sides of the core with the core in between in a major axis direction of the core as viewed in the central axis direction.

According to the above-described embodiment, since the first attachment base portion and the second attachment base portion are positioned on respective sides of the core with the core in between in the major axis direction of the core as viewed in the central axis direction, a first electrode terminal attached to the first attachment base portion and a second electrode terminal attached to the second attachment base portion can be disposed in the major axis direction of the core with respect to the core. As a result, the coils connected to the first electrode terminal and the second electrode terminal can be wound around long side parts of the oval shape of the core along the major axis direction of the core, thereby ensuring the number of turns of the coil.

Preferably, in one embodiment of the coil component, the slit hole includes a plurality of slit holes included in the first attachment base portion and a plurality of slit holes included in the second attachment base portion.

According to the above-described embodiment, since the first attachment base portion and the second attachment base portion each include the plurality of slit holes, the electrode terminal can be inserted into each slit hole.

Preferably, in one embodiment of the coil component, an outer surface of the coupling portion on a side opposite to the outer end face includes a fillet forming region on which solder spreads upward.

According to the above-described embodiment, when the coil component is mounted on the mounting substrate, the solder wets the fillet forming region of the coupling portion, so that the mounting strength of the coil component with respect to the mounting substrate can be improved. In addition, when the coil component is mounted on the mounting substrate, vibrations or impacts applied to the coil component may cause stress on the coupling portion. However, since the solder wets the fillet forming region of the coupling portion, the stress can be reduced by the solder. Further, since the coupling portion faces the outer end face, the solder can be confirmed from the outside.

Preferably, in one embodiment of the coil component, an end face of a tip portion of the second flat plate portion on a side opposite to the coupling portion includes a fillet forming region on which solder spreads upward.

According to the above-described embodiment, when the coil component is mounted on the mounting substrate, the solder wets the fillet forming region of the second flat plate portion, so that the mounting strength of the coil component with respect to the mounting substrate can be improved.

Preferably, in one embodiment of the coil component, a tip portion of the first flat plate portion on a side opposite to the coupling portion protrudes from the inner end face and is connected to the end portion of the coil.

According to the above-described embodiment, since the tip portion of the first flat plate portion protrudes from the inner end face, the end portion of the coil can be easily connected. Additionally, since the tip portion of the first flat plate portion is connected to the end portion of the coil, for example, in a case where the end portion of the coil is connected to the tip portion of the first flat plate portion by welding, the heat of welding is transmitted sequentially to the first flat plate portion and the coupling portion. Therefore, the heat of welding is less likely to be transmitted to the second flat plate portion, and discoloration or modification of a plating layer, such as Ni or Sn, on the second flat plate portion can be reduced, thereby ensuring mounting reliability.

Preferably, in one embodiment of the coil component, a connection part between the first flat plate portion and the end portion of the coil is covered with an adhesive member made of a resin.

According to the above-described embodiment, since the connection part between the first flat plate portion and the end portion of the coil is covered with the adhesive member made of a resin, the fixation and insulation of the connection part can be reliably ensured. In addition, the first flat plate portion is fixed to the adhesive member, and the electrode terminal can be prevented from slipping out of the slit hole of the attachment base portion.

Preferably, in one embodiment of the coil component, an opening dimension of the slit hole on an outer end face side in a short side direction is larger than an opening dimension of the slit hole on an inner end face side in the short side direction.

According to the above-described embodiment, since the opening dimension of the slit hole on the outer end face side is larger than the opening dimension of the slit hole on the inner end face side, the first flat plate portion of the electrode terminal is easily inserted into the slit hole from the outer end face toward the inner end face.

Preferably, in one embodiment of the coil component, the first flat plate portion is press-fitted into an opening of the slit hole on at least the inner end face side.

According to the above-described embodiment, since the first flat plate portion is press-fitted into the slit hole, the electrode terminal can be firmly fixed to the attachment base portion.

Preferably, in one embodiment of the coil component, a dimension of the slit hole in the short side direction continuously decreases from the outer end face toward the inner end face.

According to the above-described embodiment, since the dimension of the slit hole in the short side direction continuously decreases from the outer end face toward the inner end face, the positioning accuracy of the electrode terminal with respect to the attachment base portion is further enhanced in the fixation of the electrode terminal to the attachment base portion.

Preferably, in one embodiment of the coil component, an inner surface of the slit hole includes a stepped surface where a dimension of the slit hole in the short side direction decreases stepwise from the outer end face toward the inner end face.

According to the above-described embodiment, since the inner surface of the slit hole includes the stepped surface, the first flat plate portion of the electrode terminal is smoothly and easily inserted into the slit hole from the outer end face toward the inner end face.

Preferably, in one embodiment of the coil component, the stepped surface is an inclined surface where the dimension of the slit hole in the short side direction continuously decreases from the outer end face toward the inner end face.

According to the above-described embodiment, since the stepped surface is the inclined surface, the first flat plate portion of the electrode terminal is smoothly and easily inserted into the slit hole from the outer end face toward the inner end face.

With the coil component of one aspect of the present disclosure, detachment of the electrode terminal from the attachment base portion can be reduced.

### BRIEF DESCRIPTION OF THE DRAWINGS

FIG. 1 is a top perspective view showing a coil component of a first embodiment;

FIG. 2 is a bottom perspective view of the coil component.

FIG. 3 is a bottom perspective view showing an interior of the coil component.

FIG. 4 is an exploded perspective view of the coil component.

FIG. 5 is a schematic sectional view of the coil component.

FIG. 6 is a sectional view taken along line VI-VI of FIG. 1.

FIG. 7 is a top perspective view of a connection part between an endmost straight pin member and a bent pin member in a first coil.

FIG. 8 is a top perspective view of a first electrode terminal.

FIG. 9 is a sectional view of the first electrode terminal.

FIG. 10 is a top perspective view of a base case.

FIG. 11 is a bottom perspective view of the base case.

FIG. 12 is a sectional view of a part of the base case including a slit hole of a first attachment base portion.

FIG. 13 is a bottom view of the coil component excluding a bottom plate portion and a coil adhesive member.

FIG. 14 is a sectional view taken along line XIV-XIV of FIG. 13.

FIG. 15 shows a coil component of a second embodiment and is a sectional view of a part of a base case including a slit hole of a first attachment base portion.

### DETAILED DESCRIPTION

Hereinafter, a coil component and a manufacturing method thereof, which are one aspect of the present disclosure, will be described in detail with reference to the illustrated embodiments. Note that the drawings include some schematic representations and do not reflect the actual dimensions or proportions in some cases.

### First Embodiment

### (Overall Configuration of Coil Component)

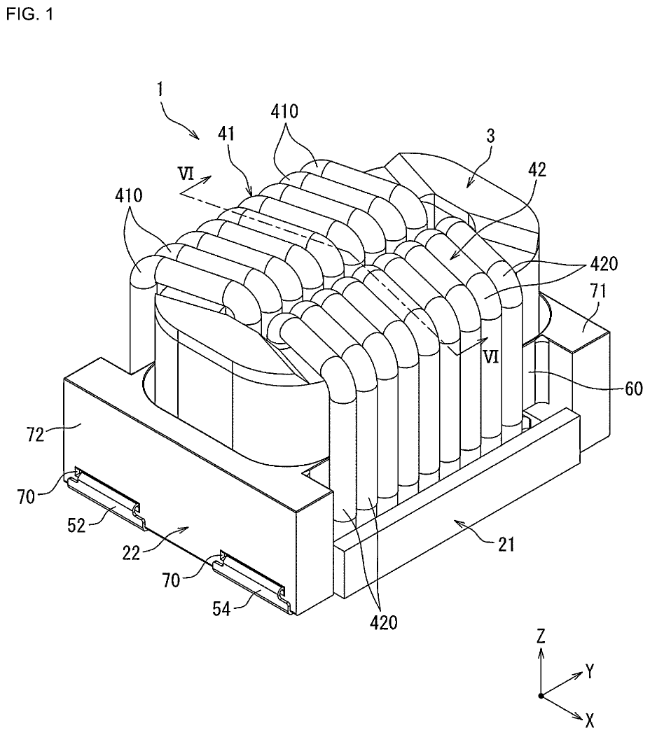

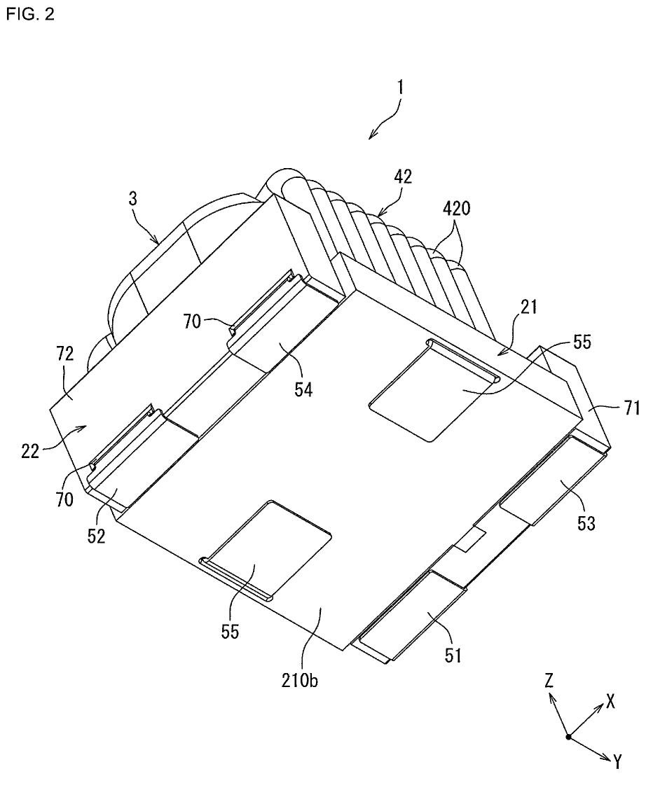

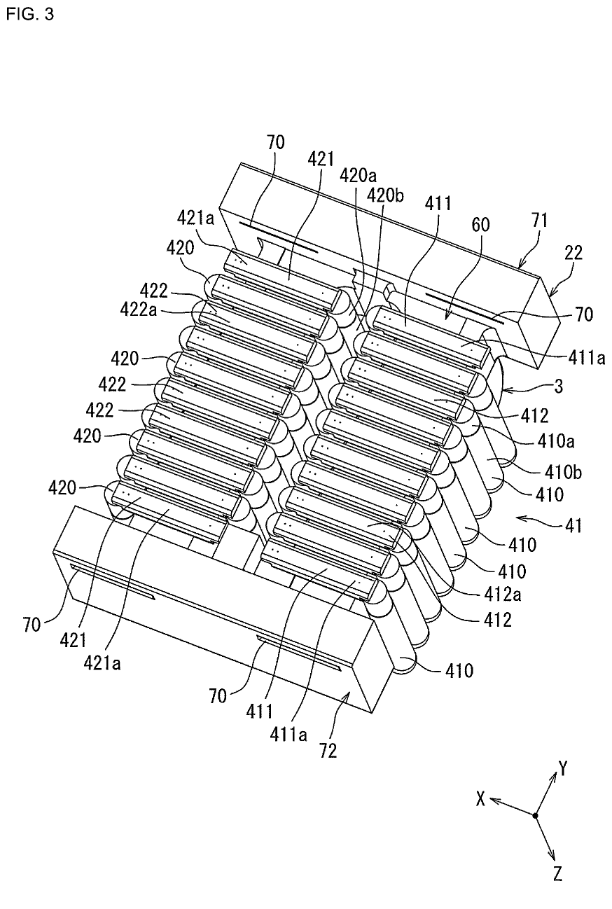

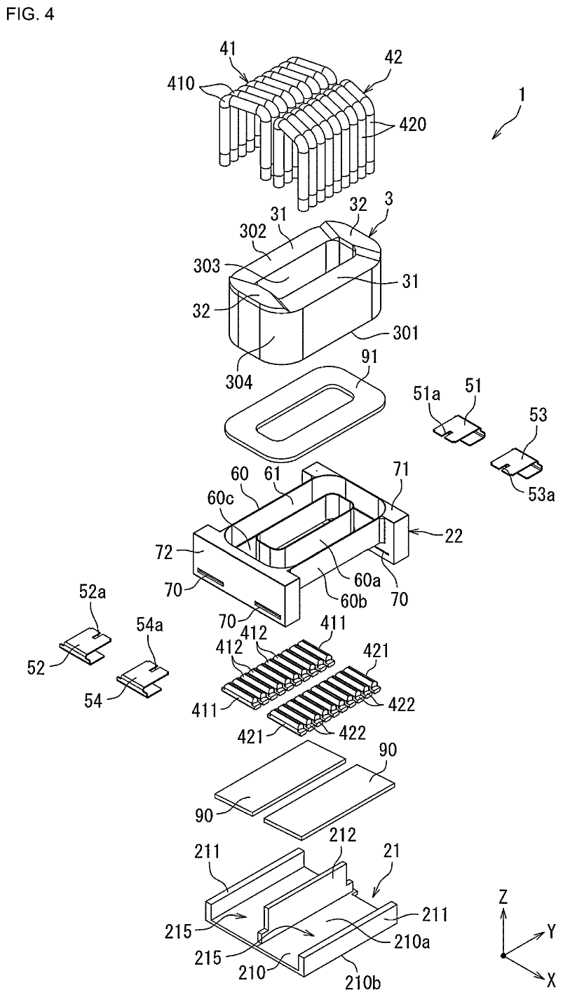

FIG. 1 is a top perspective view showing a coil component of one embodiment of the present disclosure. FIG. 2 is a bottom perspective view of the coil component. FIG. 3 is a bottom perspective view showing an interior of the coil component. FIG. 4 is an exploded perspective view of the coil component. As shown in FIGS. 1 to 4, a coil component 1 includes a core 3 having an annular shape, a base case 22 that covers at least a part of the core 3, a first coil 41 and a second coil 42 wound around the core 3 and the base case 22, first to fourth electrode terminals 51 to 54 attached to the base case 22, and a bottom plate portion 21 attached to the base case 22. The coil component 1 is, for example, a common mode choke coil or the like.

The base case 22 and the bottom plate portion 21 are made of a material having strength and heat resistance, and preferably, are made of a flame-retardant material. The base case 22 is made of, for example, a resin such as polyphenylene sulfide (PPS), a liquid crystal polymer (LCP), or polyphthalamide (PPA), or ceramics.

The base case 22 includes a core cover portion 60 that covers at least a part of the core 3, a first attachment base portion 71 to which the first and third electrode terminals 51 and 53 are attached, and a second attachment base portion 72 to which the second and fourth electrode terminals 52 and 54 are attached. The core cover portion 60, the first attachment base portion 71, and the second attachment base portion 72 are integrated into a single molded component.

The core cover portion 60 is an annular container body. Specifically, the core cover portion 60 includes an inner peripheral portion 60a, an outer peripheral portion 60b, and a bottom portion 60c. The core cover portion 60 includes an annular recess portion 61 that covers a lower part of the core 3. The annular recess portion 61 is a space surrounded by the inner peripheral portion 60a, the outer peripheral portion 60b, and the bottom portion 60c. The core cover portion 60 (annular recess portion 61) is an oval (track-shaped) annular body. The shape of the core cover portion 60 may be a rectangular shape, an elliptical shape, or a circular shape.

The first attachment base portion 71 and the second attachment base portion 72 are formed in a rectangular parallelepiped flange shape and are positioned on respective sides of the core cover portion 60 with the core cover portion 60 in between. Specifically, the first attachment base portion 71 and the second attachment base portion 72 are positioned outside the core cover portion 60 in a radial direction. In this embodiment, the first attachment base portion 71 and the second attachment base portion 72 are positioned outside the annular recess portion 61 in the major axis direction.

The first attachment base portion 71 includes respective notch-shaped slit holes 70 into which the first and third electrode terminals 51 and 53 are inserted. The second attachment base portion 72 includes respective notch-shaped slit holes 70 into which the second and fourth electrode terminals 52 and 54 are inserted.

The bottom plate portion 21 includes a bottom portion 210, two side wall portions 211, and a partition wall portion 212. The bottom portion 210 includes a first main surface 210a and a second main surface 210b facing each other. The two side wall portions 211 are provided on the first main surface 210a of the bottom portion 210 along respective sides of the bottom portion 210 that constitute a pair and face each other. The partition wall portion 212 is provided on the first main surface 210a of the bottom portion 210 between the two side wall portions 211. The bottom plate portion 21 includes a recess portion 215, and the recess portion 215 is formed by being surrounded by the bottom portion 210, the side wall portion 211, and the partition wall portion 212.

The bottom plate portion 21 is attached to a bottom portion 60c side of the core cover portion 60. The bottom plate portion 21 is attached to the base case 22 such that a central axis of the core 3 is orthogonal to the first main surface 210a of the bottom portion 210. The central axis of the core 3 refers to a central axis of an inner hole of the core 3. The shape of the bottom plate portion 21 is square as viewed in a central axis direction of the core 3. In this embodiment, the shape of the bottom plate portion 21 is rectangular as viewed in the central axis direction of the core 3.

Here, a direction in which the first attachment base portion 71 and the second attachment base portion 72 face each other as viewed in the central axis direction of the core 3 is referred to as a Y direction, a direction orthogonal to the Y direction as viewed in the central axis direction of the core 3 is referred to as an X direction, and a height direction of the coil component 1, which is a direction perpendicular to both the X direction and the Y direction, is referred to as a Z direction. The bottom plate portion 21 and the base case 22 are disposed to face each other in the Z direction, with the bottom plate portion 21 being on the lower side and the base case 22 being on the upper side, and the upper side is referred to as a positive direction in the Z direction, and the lower side is referred to as a negative direction in the Z direction. That is, in the height direction orthogonal to the first main surface 210a, a direction from the first main surface 210a toward the core 3 is referred to as an upper direction. In this embodiment, the Y direction is a major axis direction of the core cover portion 60, and the X direction is a minor axis direction of the core cover portion 60.

The first to fourth electrode terminals 51 to 54 are attached to the base case 22. The first electrode terminal 51 and the second electrode terminal 52 are positioned at two corners of the base case 22 facing each other in the Y direction, and the third electrode terminal 53 and the fourth electrode terminal 54 are positioned at two corners of the base case 22 facing each other in the Y direction. The first electrode terminal 51 and the third electrode terminal 53 face each other in the X direction, and the second electrode terminal 52 and the fourth electrode terminal 54 face each other in the X direction.

The first and third electrode terminals 51 and 53 are inserted into and attached to the respective slit holes 70 of the first attachment base portion 71. The second and fourth electrode terminals 52 and 54 are inserted into and attached to the respective slit holes 70 of the second attachment base portion 72. Specifically, the first to fourth electrode terminals 51 to 54 are each a metal plate bent into a U-shape. One end portions of the first to fourth electrode terminals 51 to 54 are inserted into the respective slit holes 70 and are each connected to the coil 41 or 42. The one end portions of the first to fourth electrode terminals 51 to 54 include slit portions 51a to 54a, respectively. The other end portions of the first to fourth electrode terminals 51 to 54 are each positioned outside the attachment base portion 71 or 72 and are connected to a mounting substrate (not shown).

A dummy terminal 55 is attached to the second main surface 210b of the bottom plate portion 21. For example, the dummy terminal 55 is bonded to the second main surface 210b by an adhesive member or the like. The dummy terminal 55 is not electrically connected to the first coil 41 or the second coil 42. By providing the dummy terminal 55, when the coil component 1 is mounted on a mounting substrate (not shown), in addition to the first to fourth electrode terminals 51 to 54, the dummy terminal 55 can also be connected to the mounting substrate with solder interposed therebetween. As a result, the mounting strength of the coil component 1 can be improved.

The core 3 is a toroidal core, and the core 3 is an oval (track-shaped) annular body as viewed in the central axis direction. The core 3 includes a pair of long side parts 31 that extend along a major axis and face each other in the minor axis direction, and a pair of short side parts 32 that extend along a minor axis and face each other in the major axis direction, as viewed in the central axis direction. The shape of the core 3 may be a rectangular shape, an elliptical shape, or a circular shape as viewed in the central axis direction.

The core 3 is composed of, for example, a ceramic core made of ferrite or the like, or a magnetic core produced using iron-based powder molding or a nanocrystal foil. The core 3 includes a first end face 301 and a second end face 302 facing each other in the central axis direction, and an inner peripheral surface 303 and an outer peripheral surface 304. The first end face 301 is a lower end face of the core 3 and is positioned on a bottom plate portion 21 side. The second end face 302 is an upper end face of the core 3. The short side part 32 includes a protruding portion on the second end face 302. That is, a region of the second end face 302, which is positioned on the short side part 32, is positioned on the upper side in the Z direction with respect to a region of the second end face 302, which is positioned on the long side part 31.

The shape of the cross-section of the core 3 that is orthogonal to a circumferential direction as viewed in the central axis direction is square. The first end face 301 and the second end face 302 are disposed perpendicular to the central axis direction of the core 3. The inner peripheral surface 303 and the outer peripheral surface 304 are disposed parallel to the central axis direction of the core 3. In this specification, the term “perpendicular” is not limited to a completely perpendicular state and also includes a substantially perpendicular state. Additionally, the term “parallel” is not limited to a completely parallel state and also includes a substantially parallel state.

The core 3 is housed in the core cover portion 60 of the base case 22 such that the major axis direction of the core 3 coincides with the Y direction. A part of the core 3 on a first end face 301 side is covered with the core cover portion 60. That is, the lower part of the core 3 is fitted into the annular recess portion 61 of the core cover portion 60, and the core 3 can be mounted on the core cover portion 60. A part of the core 3 on at least the first end face 301 side need only be covered with the core cover portion 60, and the entire core 3 may be covered with the core cover portion 60.

The core 3 is connected to the core cover portion 60 with a core adhesive member 91 interposed therebetween. The core adhesive member 91 is disposed in the annular recess portion 61 and bonds the first end face 301 of the core 3 and the bottom portion 60c of the core cover portion 60 to each other.

The first coil 41 and the second coil 42 are each connected to the bottom plate portion 21 with a coil adhesive member 90 interposed therebetween. The coil adhesive member 90 is disposed in the recess portion 215 of the bottom plate portion 21 and comes into contact with the first coil 41 or the second coil 42, and the base case 22.

The first coil 41 is wound around the core 3 and the core cover portion 60 between the first electrode terminal 51 and the second electrode terminal 52. One end of the first coil 41 is connected to the first electrode terminal 51. The other end of the first coil 41 is connected to the second electrode terminal 52.

The second coil 42 is wound around the core 3 and the core cover portion 60 between the third electrode terminal 53 and the fourth electrode terminal 54. One end of the second coil 42 is connected to the third electrode terminal 53. The other end of the second coil 42 is connected to the fourth electrode terminal 54.

The first coil 41 and the second coil 42 are spirally wound around the core 3 and the core cover portion 60 along the circumferential direction of the core 3 as viewed in the central axis direction of the core 3. Specifically, the first coil 41 is wound around one long side part 31 of the core 3 and the core cover portion 60 along the major axis direction of the core 3, and the second coil 42 is wound around the other long side part 31 of the core 3 and the core cover portion 60 along the major axis direction of the core 3. A winding axis of the first coil 41 and a winding axis of the second coil 42 run parallel to each other. The first coil 41 and the second coil 42 are symmetrical with respect to the major axis of the core 3.

The number of turns of the first coil 41 and the number of turns of the second coil 42 are the same. A winding direction of the first coil 41 with respect to the core 3 and a winding direction of the second coil 42 with respect to the core 3 are opposite to each other. That is, the winding direction of the first coil 41 from the first electrode terminal 51 toward the second electrode terminal 52 and the winding direction of the second coil 42 from the third electrode terminal 53 toward the fourth electrode terminal 54 are opposite to each other.

Then, the first to fourth electrode terminals 51 to 54 are connected such that the common-mode current flows from the first electrode terminal 51 toward the second electrode terminal 52 in the first coil 41 and flows from the third electrode terminal 53 toward the fourth electrode terminal 54 in the second coil 42, that is, the directions in which the current flows are the same. When the common-mode current flows to the first coil 41, a first magnetic flux is generated by the first coil 41 in the core 3. When the common-mode current flows to the second coil 42, a second magnetic flux is generated in the core 3 in a direction in which the first magnetic flux and the second magnetic flux are reinforced in the core 3. Therefore, the first coil 41 and the core 3, and the second coil 42 and the core 3 act as inductance components, and noise is removed from the common-mode current.

The first coil 41 is formed by connecting a plurality of pin members through, for example, welding such as laser welding or spot welding. FIG. 3 does not represent a state in which the plurality of pin members are actually welded, but rather represents a state in which the plurality of pin members are assembled. In addition, the method of connecting the plurality of pin members is not limited to welding, and another connection method using, for example, solder, a conductive adhesive member, or the like may be employed. In the following description, for the sake of simplicity, it is assumed that welding is employed as the method of connecting the plurality of pin members.

The plurality of pin members are rod-shaped members, rather than being printed wiring or conductive wires. The pin members have rigidity. Specifically, in a cross-section orthogonal to the circumferential direction of the core 3, each of the pin members is shorter than the length of one circumference of the outer periphery of the core, which passes through the first end face 301, the second end face 302, the inner peripheral surface 303, and the outer peripheral surface 304 of the core 3, and also due to its high rigidity, the pin member is difficult to bend. The plurality of pin members include a plurality of bent pin members 410 that are bent into a substantially U-shape and a plurality of straight pin members 411 and 412 that extend in a substantially straight line. The straight pin members 411 and 412 and the bent pin members 410 are alternately connected to each other to form a spiral of the first coil 41. The plurality of straight pin members 411 and 412 include an endmost straight pin member 411 positioned at an endmost position on at least one side of the first coil 41 in an axial direction. A straight pin member other than the endmost straight pin member 411 among the plurality of straight pin members is referred to as a normal straight pin member 412 (hereinafter, simply referred to as a straight pin member 412).

The first coil 41 includes, in order from one end to the other end, one endmost straight pin member 411 on one end side, a plurality of sets of bent pin members 410 and straight pin members 412, and the other endmost straight pin member 411 on the other end side. In this embodiment, the endmost straight pin member 411 and the straight pin member 412 have the same shape. However, the shape is not limited thereto, and the endmost straight pin member 411 and the straight pin member 412 may have different shapes. For example, the length of the endmost straight pin member 411 in an extension direction may be made shorter than the length of the straight pin member 412 in the extension direction.

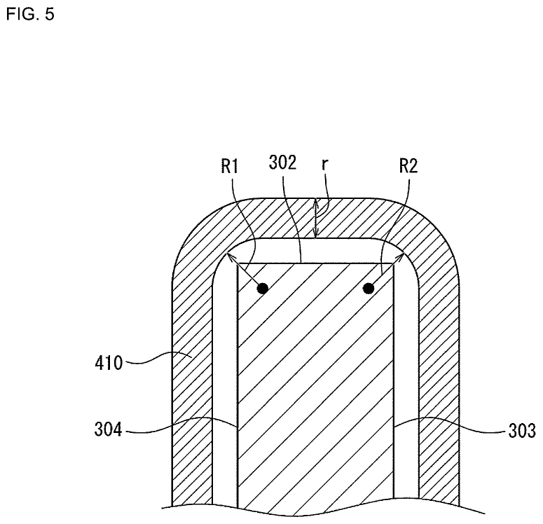

Regarding a spring index of the bent pin member 410, as shown in FIG. 5, when the bent pin member 410 is disposed along the second end face 302, the inner peripheral surface 303, and the outer peripheral surface 304 of the core 3, a spring index Ks of the bent pin member 410 is less than 3.6 in a curvature radius R1 of the bent pin member 410 positioned at a corner portion of the outer peripheral surface 304 of the core 3 and a curvature radius R2 of the bent pin member 410 positioned at a corner portion of the inner peripheral surface 303 of the core 3. The spring index Ks can be represented by the curvature radii R1 and R2 of the bent pin member/a wire diameter r of the bent pin member. As described above, the bent pin member 410 has high rigidity and is difficult to bend.

The bent pin member 410 and the straight pin member 412 are alternately connected by, for example, welding such as laser welding or spot welding. One end of the straight pin member 412 is connected to one end of the bent pin member 410, and the other end of the straight pin member 412 is connected to one end of another bent pin member 410. By repeating this, the plurality of bent pin members 410 and straight pin members 412 are connected, and the connected plurality of bent pin members 410 and straight pin members 412 are disposed in a spiral shape on the core 3. That is, one set of the bent pin member 410 and the straight pin member 412 forms one turn.

The bent pin member 410 is disposed parallel to each of the second end face 302, the inner peripheral surface 303, and the outer peripheral surface 304 of the core 3. In the bent pin member 410, a virtual line connecting both end portions in the extension direction is slightly inclined in the Y direction and extends in the X direction as viewed in the central axis direction of the core 3. In other words, the bent pin member 410 is disposed such that a plane including a center line of the bent pin member 410 is slightly inclined in the Y direction with respect to a plane (XZ plane) orthogonal to the axial direction of the first coil 41. The straight pin member 412 is disposed parallel to the first end face 301 of the core 3. The straight pin member 412 extends in the X direction. The endmost straight pin member 411 is disposed parallel to the first end face 301 of the core 3. The endmost straight pin member 411 extends in a direction parallel to the straight pin member 412.

The first electrode terminal 51 is connected to one endmost straight pin member 411, and the one endmost straight pin member 411 is connected to one end of the bent pin member 410 of the turn adjacent to the one endmost straight pin member 411. A part of the first electrode terminal 51 faces the one endmost straight pin member 411, and a peripheral surface of the one endmost straight pin member 411 is connected to the first electrode terminal 51. Specifically, a part of the first electrode terminal 51 penetrates the slit hole 70 of the first attachment base portion 71 and is connected to the peripheral surface of the one endmost straight pin member 411.

The second electrode terminal 52 is connected to the other endmost straight pin member 411, and the other endmost straight pin member 411 is connected to one end of the bent pin member 410 of the turn adjacent to the other endmost straight pin member 411. A part of the second electrode terminal 52 faces the other endmost straight pin member 411, and the peripheral surface of the other endmost straight pin member 411 is connected to the second electrode terminal 52. Specifically, a part of the second electrode terminal 52 penetrates the slit hole 70 of the second attachment base portion 72 and is connected to the peripheral surface of the other endmost straight pin member 411.

The second coil 42 is composed of a plurality of pin members, similar to the first coil 41. That is, the second coil 42 includes, in order from one end to the other end, one endmost straight pin member 421 on one end side, a plurality of sets of bent pin members 420 and straight pin members 422, and the other endmost straight pin member 421 on the other end side. The bent pin members 420 and the straight pin members 422 are alternately connected and wound around the core 3. That is, the plurality of bent pin members 420 and straight pin members 422 are connected, and the connected plurality of bent pin members 420 and straight pin members 422 are spirally wound around the core 3.

The third electrode terminal 53 is connected to one endmost straight pin member 421, and the one endmost straight pin member 421 is connected to one end of the bent pin member 420 of the turn adjacent to the one endmost straight pin member 421. A part of the third electrode terminal 53 faces the one endmost straight pin member 421, and a peripheral surface of the one endmost straight pin member 421 is connected to the third electrode terminal 53. Specifically, a part of the third electrode terminal 53 penetrates the slit hole 70 of the first attachment base portion 71 and is connected to the peripheral surface of the one endmost straight pin member 421.

The fourth electrode terminal 54 is connected to the other endmost straight pin member 421, and the other endmost straight pin member 421 is connected to one end of the bent pin member 420 of the turn adjacent to the other endmost straight pin member 421. A part of the fourth electrode terminal 54 faces the other endmost straight pin member 421, and a peripheral surface of the other endmost straight pin member 421 is connected to the fourth electrode terminal 54. Specifically, a part of the fourth electrode terminal 54 penetrates the slit hole 70 of the second attachment base portion 72 and is connected to the peripheral surface of the other endmost straight pin member 421.

As shown in FIG. 3, it is preferable that the first coil 41 and the second coil 42 (pin members 410 to 412 and 420 to 422) each include a conductor portion and a coating film that covers a part of the conductor portion. The conductor portion is, for example, a copper wire, and the coating film is, for example, a polyamide-imide resin. The thickness of the coating film is, for example, 0.02 to 0.04 mm.

The endmost straight pin members 411 and 421 are composed of conductor portions 411a and 421a without coating films. The straight pin members 412 and 422 are composed of conductor portions 412a and 422a without coating films. The bent pin members 410 and 420 are composed of conductor portions 410a and 420a and coating films 410b and 420b.

At one ends and the other ends of the bent pin members 410 and 420, the conductor portions 410a and 420a are exposed from the coating films 410b and 420b. That is, the endmost straight pin members 411 and 421, the straight pin members 412 and 422, and the bent pin members 410 and 420 are, for example, welded to each other at the exposed conductor portions 411a, 421a, 412a, 422a, 410a, and 420a. The conductor portions that are not covered with the coating films, that is, the conductor portions that are exposed from the coating films (without coating films) are capable of electrical conduction with the outside.

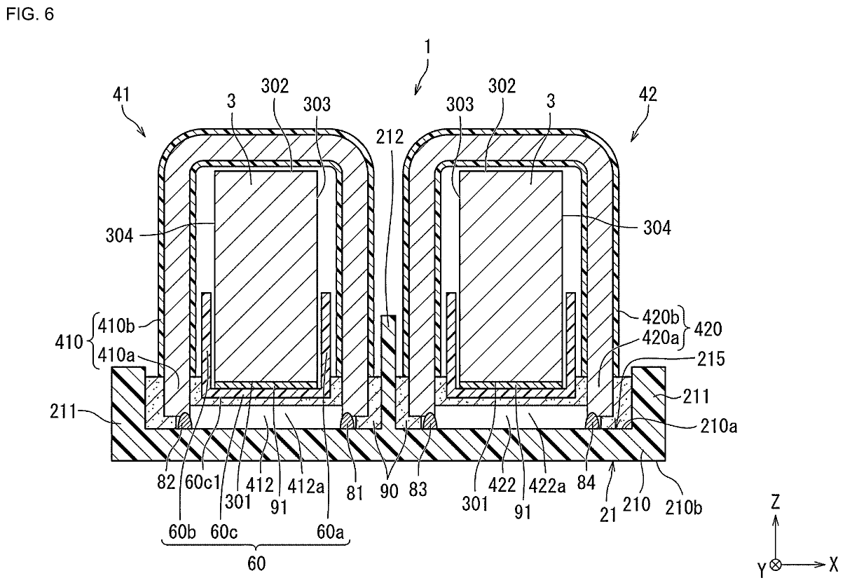

FIG. 6 is a sectional view taken along line VI-VI of FIG. 1. In FIG. 6, the dummy terminal 55 is not shown. As shown in FIG. 6, the first coil 41 includes a welded portion in which end portions of adjacent pin members are welded to each other. The welded portion refers to a part that is once melted during the welding and then solidified. Specifically, the first coil 41 includes a first welded portion 81 and a second welded portion 82. More specifically, in adjacent turns of the first coil 41, the straight pin member 412 and the bent pin member 410 of one turn form the first welded portion 81 in which one conductor portion 412a of the straight pin member 412 and the conductor portion 410a of the bent pin member 410 are welded to each other, and the above-described straight pin member 412 and the bent pin member 410 of the other turn form the second welded portion 82 in which the other conductor portion 412a of the straight pin member 412 and the conductor portion 410a of the bent pin member are welded to each other.

In FIG. 6, the turn composed of the straight pin member 412 and the bent pin member 410 of the first coil 41 is described, but the same applies to the turn composed of the endmost straight pin member 411 and the bent pin member 410. Specifically, the endmost straight pin member 411 is welded at the conductor portion 410a of the bent pin member 410 connected to the conductor portion 411a to form the first welded portion 81 or the second welded portion 82.

The second coil 42 includes a third welded portion 83 and a fourth welded portion 84. In the second coil 42, similar to the first coil 41, in adjacent turns, the straight pin member 422 and the bent pin member 420 of one turn are welded at one conductor portion 422a of the straight pin member 422 and the conductor portion 420a of the bent pin member 420 to form the third welded portion 83, and the above-described straight pin member 422 and the bent pin member 420 of the other turn are welded at the other conductor portion 422a of the straight pin member 422 and the conductor portion 420a of the bent pin member to form the fourth welded portion 84. Additionally, the endmost straight pin member 421 is welded at the conductor portion 420a of the bent pin member 420 connected to the conductor portion 421a to form the third welded portion 83 or the fourth welded portion 84. The third welded portion 83 and the fourth welded portion 84 of the second coil 42 have the same configurations as those of the first welded portion 81 and the second welded portion 82 of the first coil 41, and the description thereof will be omitted.

The core cover portion 60 is present between the welded portions and conductor portions exposed from the coating films in the coils 41 and 42, and the core 3. As a result, the welded portions and conductor portions of the coils 41 and 42, and the core 3 can be more reliably insulated from each other.

The core cover portion 60 is provided over the first end face 301 of the core 3, a part of the inner peripheral surface 303 of the core 3, and a part of the outer peripheral surface 304 of the core 3. The core cover portion 60 includes the inner peripheral portion 60a facing the inner peripheral surface 303 of the core 3, the outer peripheral portion 60b facing the outer peripheral surface 304 of the core 3, and the bottom portion 60c facing the first end face 301 of the core 3. The bottom portion 60c includes a first surface 60c1 on a side opposite to the first end face 301.

The core 3 is connected to the core cover portion 60 with the core adhesive member 91 interposed therebetween. By connecting the core adhesive member 91 to a part of the core 3, the stress of the core 3 received from the core cover portion 60 can be reduced, thereby suppressing the deterioration of magnetic characteristics of the core 3. That is, a decrease in inductance value caused by magnetostriction can be suppressed. The core cover portion 60 may simply be fitted into the core 3 without being connected to the core 3 with the core adhesive member 91 interposed therebetween.

The core adhesive member 91 is provided between the first end face 301 of the core 3 and the bottom portion 60c of the core cover portion 60. As a result, the influence of the magnetostriction on the core 3 can be reduced, while ensuring a stable attachment state of the core cover portion 60 to the core 3.

Examples of the material of the core adhesive member 91 include a soft resin such as a urethane resin or a silicone resin. By providing such a soft resin, the influence of magnetostriction can be reduced.

In FIG. 6, the core adhesive member 91 is provided in the entire region between the first end face 301 of the core 3 and the bottom portion 60c of the core cover portion 60, but may be provided only in a part thereof. In addition, in FIG. 6, the core adhesive member 91 is provided between the first end face 301 of the core 3 and the bottom portion 60c of the core cover portion 60, but may be provided between the inner peripheral surface 303 of the core 3 and the inner peripheral portion 60a of the core cover portion 60 or may be provided between the outer peripheral surface 304 of the core 3 and the outer peripheral portion 60b of the core cover portion 60, or may be provided at a plurality of locations among these.

As shown in FIG. 6, the conductor portions exposed from the coating films in the coil 41 or 42 are disposed in the recess portion 215 to be positioned on a first main surface 210a side. The coil adhesive member 90 is fixed in the recess portion 215, bonds the coil 41 or 42 to the bottom plate portion 21, and covers at least a part of the conductor portions exposed from the coating films in the coil 41 or 42. Preferably, the coil adhesive member 90 covers the entire conductor portions.

The coil adhesive member 90 is made of, for example, a thermosetting resin and is fixed to the coil 41 or 42, the core cover portion 60, and the bottom plate portion 21 by curing. The coil adhesive member 90 comes into contact with the inner surface of the recess portion 215, a part of the inner peripheral portion 60a of the core cover portion 60, a part of the outer peripheral portion 60b of the core cover portion 60, and a part of the bottom portion 60c of the core cover portion 60 and covers the conductor portions 411a, 412a, and 410a exposed from the coating film 410b in the first coil 41 or the conductor portions 421a, 422a, and 420a exposed from the coating film 420b in the second coil 42. Further, the coil adhesive member 90 also covers the welded portions 81 and 82 of the coil 41 or the welded portions 83 and 84 of the coil 42.

Since the coil adhesive member 90 is fixed in the recess portion 215 of the bottom plate portion 21, the coil adhesive member 90 is stably fixed to the bottom plate portion 21, thereby enabling the coil adhesive member 90 to stably fix the coil 41 or 42 to the bottom plate portion 21. Additionally, since the coil adhesive member 90 covers the conductor portions exposed from the coating films in the coil 41 or 42, it is possible to prevent malfunctions such as an electrical short with the outside. Further, in a case where the coil component 1 is subjected to an external force such as vibrations or impacts, the coil adhesive member 90 can absorb the impact and protect the coil 41 or 42.

Examples of the material of the coil adhesive member 90 include a silicone resin. By using the silicone resin, it is possible to improve reflow heat resistance and mechanical strength.

### (Detailed Configuration of Connection Portion Between Pin Members)

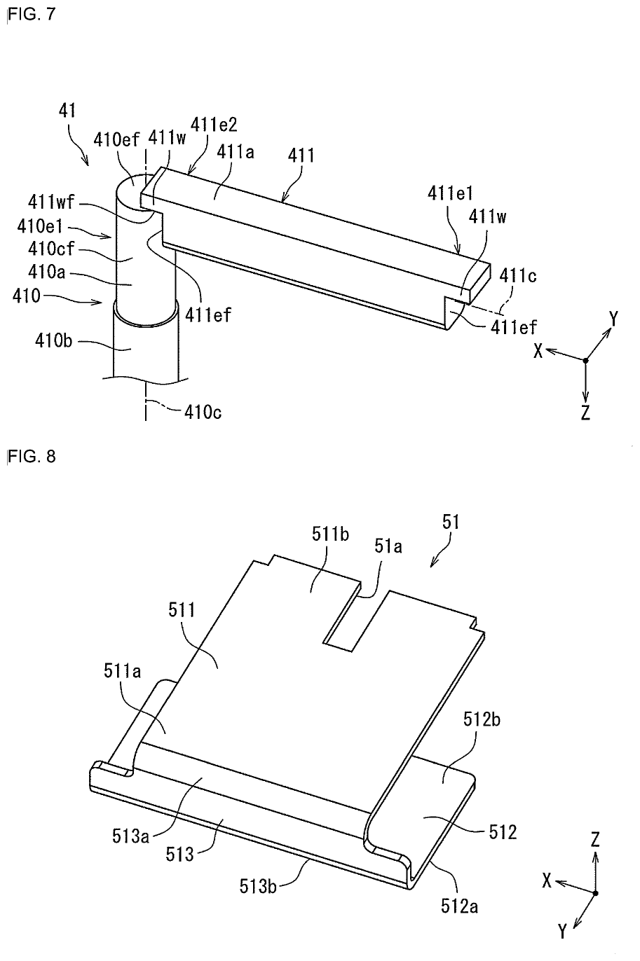

Next, a detailed configuration of a connection part between the endmost straight pin member 411 and the bent pin member 410 will be described. FIG. 7 is a top perspective view of the connection part between the endmost straight pin member 411 and the bent pin member 410 in the first coil 41. FIG. 7 shows a state immediately after the endmost straight pin member 411 is assembled to the bent pin member 410, that is, a state before the bent pin member 410 and the endmost straight pin member 411 are connected by, for example, welding or the like. The same applies to the connection part between the straight pin member 412 and the bent pin member 410, and the description thereof will be omitted. In addition, the same applies to the connection part between the straight pin members 421 and 422 and the bent pin member 420 in the second coil 42, and the description thereof will be omitted.

As shown in FIG. 7, the endmost straight pin member 411 has a square cross-section. The cross-sectional shape of the endmost straight pin member 411 is not particularly limited and may be a circular shape, an elliptical shape, a polygonal shape other than a square, or the like.

A wall portion 411w that protrudes in a direction of a center line 411c of a second end portion 411e2 is provided on an end face 411ef of the second end portion 411e2 of the endmost straight pin member 411. Similarly, a wall portion 411w that protrudes in the direction of the center line 411c of a first end portion 411e1 is provided on an end face 411ef of the first end portion 411e1 of the endmost straight pin member 411. Here, the center line 411c of the second end portion 411e2 is a line passing through the center of gravity of the second end portion 411e2 in a cross-section orthogonal to the extension direction (X direction) of the second end portion 411e2. The end face 411ef of the second end portion 411e2 is an outer surface positioned at an outermost side of the second end portion 411e2 in the direction of the center line 411c. The same applies to the end face 411ef of the first end portion 411e1. The end face 411ef is orthogonal to the direction of the center line 411c of the second end portion 411e2. The shape of the wall portion 411w is not particularly limited, but is formed in a rectangular parallelepiped shape in this embodiment. The wall portion 411w can be formed by, for example, pressing a part of the end face of the second end portion 411e2 in the direction of the center line 411c. Alternatively, the wall portion 411w can be formed by, for example, cutting a part of the end face of the second end portion 411e2.

The position where the wall portion 411w is provided on the end face 411ef is not particularly limited, but as in this embodiment, it is preferable that the wall portion 411w is provided at an end portion of the end face 411ef on a negative Z direction side, and an end face of the wall portion 411w on the negative Z direction side is flush with an end face of a part of the endmost straight pin member 411 on the negative Z direction side, excluding the wall portion 411w. As a result, the endmost straight pin member 411 can be stably assembled to the bent pin member 410, and the end face of the endmost straight pin member 411 on the negative Z direction side can be made flat, so that, for example, in a case where the end face is irradiated with a laser and welded, the welding can be performed effectively without scattering the laser.

The bent pin member 410 has a circular cross-section. The cross-sectional shape of the bent pin member 410 may be an elliptical shape, a polygonal shape, or the like. An end face 410ef of a first end portion 410e1 of the bent pin member 410 is made flat. The end face 410ef is orthogonal to a direction of a center line 410c of the first end portion 410e1. Similarly, an end face of a second end portion (not shown) of the bent pin member 410 is made flat. The end face is orthogonal to a direction of a center line of the second end portion.

The end face 411ef of the second end portion 411e2 of the endmost straight pin member 411 faces a circumferential surface 410cf of the first end portion 410e1 of the bent pin member 410. In this embodiment, a part of the end face 411ef is in contact with the circumferential surface 410cf. Here, the center line 410c of the first end portion 410e1 is a line passing through the center of gravity of the first end portion 410e1 in a cross-section orthogonal to the extension direction of the first end portion 410e1. The circumferential surface 410cf of the first end portion 410e1 is an outer surface of the first end portion 410e1 in a circumferential direction about the center line. The end face 411ef may be in contact with the circumferential surface 410cf, for example, with a conductive adhesive member or the like interposed therebetween. Among the connection parts between the plurality of pin members, there may be a connection part in which the end face 411ef is not in contact with the circumferential surface 410cf, that is, the end face 411ef and the circumferential surface 410cf are spaced apart from each other with a space therebetween.

A side surface 411wf of the wall portion 411w in a direction (positive Z direction) orthogonal to the direction of the center line 411c of the second end portion 411e2 faces the end face 410ef of the first end portion 410e1. In this embodiment, the side surface 411wf is in surface contact with the end face 410ef. In short, in this embodiment, a corner portion of the first end portion 410e1 of the bent pin member 410 is fitted into a space surrounded by the end face 411ef of the endmost straight pin member 411 and the wall portion 411w. Here, the end face 410ef of the first end portion 410e1 is an outer surface positioned at an outermost side of the first end portion 410e1 in the direction of the center line 410c. The entire surface of the side surface 411wf may be in surface contact with the end face 410ef, a part of the side surface 411wf may be in surface contact with the end face 410ef, or the side surface 411wf may be in surface contact with the end face 410ef, for example, with a conductive adhesive member or the like interposed therebetween. Among the connection parts between the plurality of pin members, there may be a connection part in which the side surface 411wf is not in surface contact with the end face 410ef, that is, the side surface 411wf and the end face 410ef are spaced apart from each other with a space therebetween.

### (Detailed Configuration of Electrode Terminal)

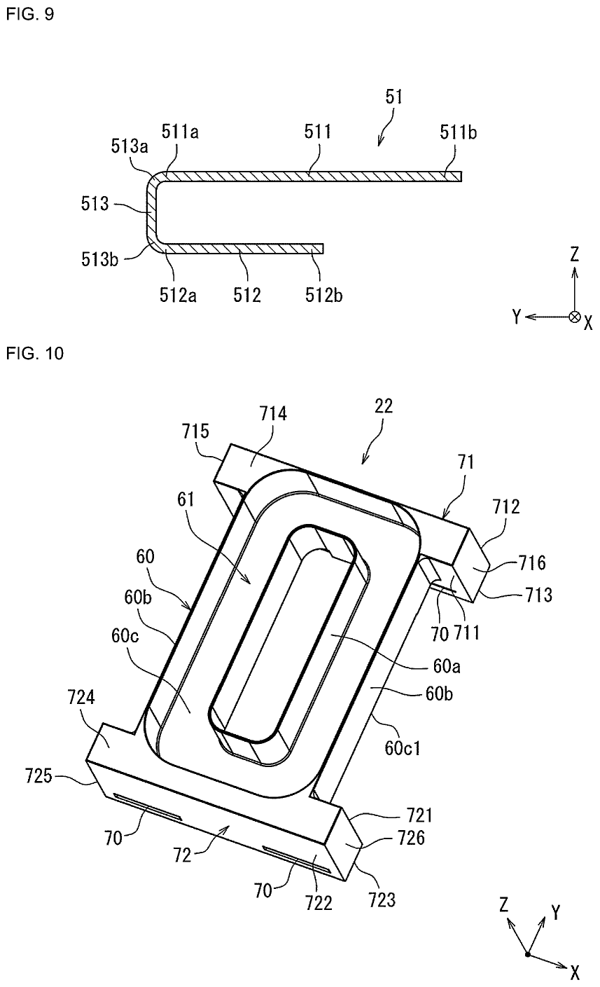

FIG. 8 is a top perspective view of the first electrode terminal 51. FIG. 9 is a sectional view of the first electrode terminal 51. Hereinafter, the first electrode terminal 51 will be described. Since the configurations of the second electrode terminal 52, the third electrode terminal 53, and the fourth electrode terminal 54 are the same as the configuration of the first electrode terminal 51, the detailed description thereof will be omitted.

As shown in FIGS. 8 and 9, the first electrode terminal 51 includes a first flat plate portion 511, a second flat plate portion 512, and a coupling portion 513 that couples the first flat plate portion 511 and the second flat plate portion 512. The first flat plate portion 511 and the second flat plate portion 512 face each other. The first electrode terminal 51 is formed by bending a metal plate into a U-shape.

The first flat plate portion 511 is formed in a flat plate shape parallel to an XY plane. The first flat plate portion 511 includes a connection portion 511a connected to a first end portion 513a of the coupling portion 513 and a tip portion 511b on a side opposite to the connection portion 511a. The tip portion 511b includes the slit portion 51a. That is, the tip portion 511b has a bifurcated shape.

The second flat plate portion 512 is formed in a flat plate shape parallel to the XY plane. The second flat plate portion 512 includes a connection portion 512a connected to a second end portion 513b of the coupling portion 513 and a tip portion 512b on a side opposite to the connection portion 512a.

The first flat plate portion 511 is positioned in the Z direction with respect to the second flat plate portion 512, and the first flat plate portion 511 and the second flat plate portion 512 face each other in the Z direction. The connection portion 511a of the first flat plate portion 511 and the connection portion 512a of the second flat plate portion 512 face each other in the Z direction.

The coupling portion 513 is formed in a flat plate shape parallel to the XZ plane except for the first end portion 513a and the second end portion 513b. The first end portion 513a and the second end portion 513b are formed in a curved shape.

The thickness of the first electrode terminal 51 is, for example, 0.3 mm. The thicknesses of the first flat plate portion 511, the second flat plate portion 512, and the coupling portion 513 are the same. The first electrode terminal 51 is composed of, for example, a copper plate and a plating layer that covers the copper plate. The plating layer is made of, for example, Ni, Sn, or the like.

### (Detailed Configuration of Base Case)

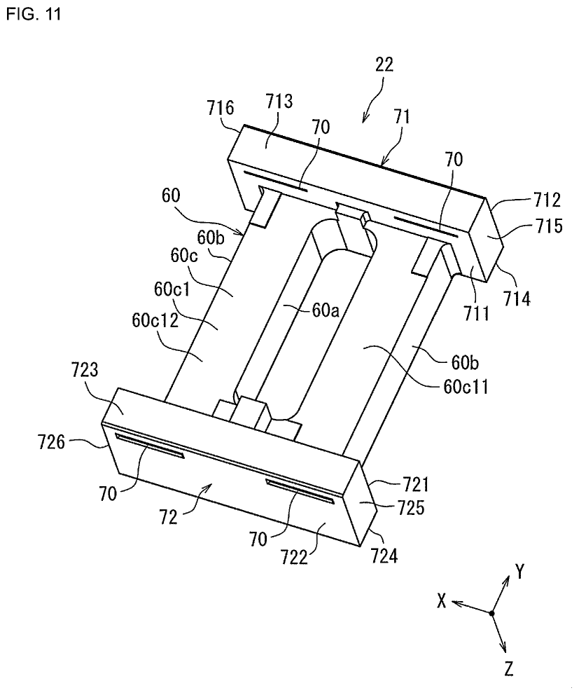

FIG. 10 is a top perspective view of the base case. FIG. 11 is a bottom perspective view of the base case. As shown in FIGS. 10 and 11, the base case 22 includes the core cover portion 60 that covers at least a part of the core 3, the first attachment base portion 71 to which the first and third electrode terminals 51 and 53 are attached, and a second attachment base portion 72 to which the second and fourth electrode terminals 52 and 54 are attached. The core cover portion 60, the first attachment base portion 71, and the second attachment base portion 72 are integrated into a single molded component. According to the above-described configuration, since the core cover portion 60 and the attachment base portions 71 and 72 are integrated, the core 3 housed in the core cover portion 60 is supported by the attachment base portions 71 and 72, thereby stabilizing the position of the core 3. Additionally, since the number of members constituting the coil component 1 can be reduced, the manufacturing process of the coil component 1 can be simplified.

The core cover portion 60 includes the inner peripheral portion 60a, the outer peripheral portion 60b, and the bottom portion 60c. The annular recess portion 61 is a space surrounded by the inner peripheral portion 60a, the outer peripheral portion 60b, and the bottom portion 60c. The core cover portion 60 is an oval annular body in which the Y direction is the major axis direction and the X direction is the minor axis direction. The bottom portion 60c includes the first surface 60c1 on a side opposite to an opening side of the annular recess portion 61. The first surface 60c1 is a surface facing the mounting substrate side when the coil component 1 is mounted on the mounting substrate.

The first surface 60c1 includes a first region 60c11 around which the first coil 41 is wound and a second region 60c12 around which the second coil 42 is wound. The first region 60c11 and the second region 60c12 correspond to the respective long side parts of the core cover portion 60 extending along the major axis.

The first attachment base portion 71 and the second attachment base portion 72 are formed in a rectangular parallelepiped flange shape and are positioned on respective sides of the core cover portion 60 with the core cover portion 60 in between. Specifically, the first attachment base portion 71 and the second attachment base portion 72 are positioned outside the core cover portion 60 in the major axis direction (Y direction). In other words, the first attachment base portion 71 and the second attachment base portion 72 are positioned on respective sides of the core 3 with the core 3 in between in the major axis direction of the core 3 as viewed in the central axis direction of the core 3. Consequently, the first electrode terminal attached to the first attachment base portion 71 and the second electrode terminal attached to the second attachment base portion 72 can be disposed in the major axis direction of the core with respect to the core. As a result, the first coil 41 connected to the first electrode terminal 51 and the second electrode terminal 52 can be wound around the long side part 31 of the oval shape of the core 3 along the major axis direction of the core 3, thereby ensuring the number of turns of the first coil 41.

The first attachment base portion 71 includes an inner end face 711 facing a core cover portion 60 side, an outer end face 712 facing a side opposite to the inner end face 711, a bottom surface 713 coupling the inner end face 711 and the outer end face 712, a top surface 714 facing a side opposite to the bottom surface 713, and two surfaces, a first side surface 715 and a second side surface 716, coupling the inner end face 711 and the outer end face 712 and coupling the bottom surface 713 and the top surface 714. The bottom surface 713 is a surface facing the mounting substrate side when the coil component 1 is mounted on the mounting substrate. The core cover portion 60 is attached to the inner end face 711 of the first attachment base portion 71.

The second attachment base portion 72 includes an inner end face 721 facing the core cover portion 60 side, an outer end face 722 facing a side opposite to the inner end face 721, a bottom surface 723 facing the mounting substrate side during mounting, a top surface 724 facing a side opposite to the bottom surface 723, and two surfaces, a first side surface 725 and a second side surface 726, coupling the inner end face 721 and the outer end face 722 and coupling the bottom surface 723 and the top surface 724. The bottom surface 723 is a surface facing the mounting substrate side when the coil component 1 is mounted on the mounting substrate. The core cover portion 60 is attached to the inner end face 721 of the second attachment base portion 72.

The first attachment base portion 71 includes a plurality of slit holes 70. The first and third electrode terminals 51 and 53 are inserted into the respective slit holes 70. The slit hole 70 is provided to penetrate the inner end face 711 and the outer end face 712 in the Y direction. The slit hole 70 extends in a direction (X direction) in which the first side surface 715 and the second side surface 716 face each other, as viewed in a direction orthogonal to the outer end face 712. One slit hole 70 into which the first electrode terminal 51 is inserted is provided on a bottom surface 713 side and a first side surface 715 side. The other slit hole 70 into which the third electrode terminal 53 is inserted is provided on the bottom surface 713 side and a second side surface 716 side.

The second attachment base portion 72 includes a plurality of slit holes 70. The second and fourth electrode terminals 52 and 54 are inserted into the respective slit holes 70. The slit hole 70 is provided to penetrate the inner end face 721 and the outer end face 722 in the Y direction. The slit hole 70 extends in a direction (X direction) in which the first side surface 725 and the second side surface 726 face each other, as viewed in a direction orthogonal to the outer end face 722. One slit hole 70 into which the second electrode terminal 52 is inserted is provided on a bottom surface 723 side and a first side surface 725 side. The other slit hole 70 into which the fourth electrode terminal 54 is inserted is provided on the bottom surface 723 side and a second side surface 726 side.

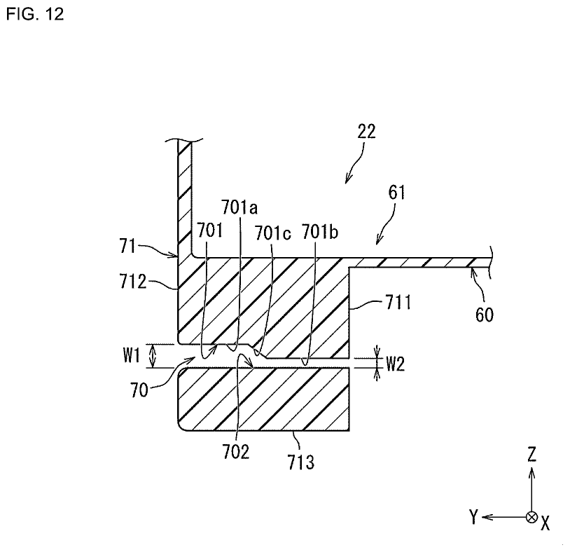

FIG. 12 is a sectional view of a part of the base case 22 including the slit hole 70 of the first attachment base portion 71. Hereinafter, the slit hole 70 of the first attachment base portion 71 will be described. Since the configuration of the slit hole 70 of the second attachment base portion 72 is the same as the configuration of the slit hole 70 of the first attachment base portion 71, the detailed description thereof will be omitted.

As shown in FIGS. 11 and 12, the slit hole 70 is an elongated hole extending in the X direction as viewed in a direction orthogonal to the inner end face 711 or the outer end face 712. That is, the long side direction of the slit hole 70 is the X direction which is the extension direction of the slit hole 70, and the short side direction of the slit hole 70 is the Z direction which is a direction orthogonal to the extension direction of the slit hole 70. The first flat plate portion 511 of the first electrode terminal 51 is inserted into the slit hole 70.

An opening dimension W1 of the slit hole 70 on an outer end face 712 side in the short side direction is larger than an opening dimension W2 of the slit hole 70 on an inner end face 711 side in the short side direction. With this configuration, the first flat plate portion 511 of the first electrode terminal 51 is easily inserted into the slit hole 70 from the outer end face 712 toward the inner end face 711.

Preferably, the first flat plate portion 511 of the first electrode terminal 51 is press-fitted into an opening of the slit hole 70 on at least the inner end face 711 side. With this configuration, the first flat plate portion 511 can be press-fitted into the slit hole 70, and the first electrode terminal 51 can be firmly fixed to the first attachment base portion 71. In addition, the coil adhesive 90 does not leak out from the slit holes 70 to outside the base case 22. Preferably, in a state before the first flat plate portion 511 is inserted into the slit hole 70, that is, in a state in which the first flat plate portion 511 is separated from the slit hole 70, the opening dimension W2 of the slit hole 70 on the inner end face 711 side is smaller than the thickness of the first flat plate portion 511 of the first electrode terminal 51. With this configuration, the first flat plate portion 511 can be press-fitted into the slit hole 70, and the first electrode terminal 51 can be firmly fixed to the first attachment base portion 71.

An inner surface of the slit hole 70 includes a stepped surface 701c where a dimension of the slit hole 70 in the short side direction decreases stepwise from the outer end face 712 toward the inner end face 711. With this configuration, the first flat plate portion 511 of the first electrode terminal 51 is smoothly and easily inserted into the slit hole 70 from the outer end face 712 toward the inner end face 711.

Specifically, in a cross-section (YZ cross-section) including the short side direction (Z direction) of the slit hole 70 and the penetration direction (Y direction) of the slit hole 70, the inner surface of the slit hole 70 includes a first inner surface 701 on the upper side in the Z direction and a second inner surface 702 on the lower side in the Z direction. The second inner surface 702 is a flat surface parallel to the Y direction. The first inner surface 701 includes a first surface 701a on the outer end face 712 side, a second surface 701b on the inner end face 711 side, and the stepped surface 701c connecting the first surface 701a and the second surface 701b. The first surface 701a and the second surface 701b are each a flat surface parallel to the Y direction. The second surface 701b is closer to the second inner surface 702 than the first surface 701a. The stepped surface 701c is an inclined surface where the dimension of the slit hole 70 in the short side direction continuously decreases from the outer end face 712 toward the inner end face 711. That is, the stepped surface 701c is inclined at an angle smaller than 90° with respect to the penetration direction (Y direction) of the slit hole 70. With this configuration, since the stepped surface 701c is an inclined surface, the first flat plate portion 511 of the first electrode terminal 51 is smoothly and easily inserted into the slit hole 70 from the outer end face 712 toward the inner end face 711.

### (Connection Relationship Between Endmost Straight Pin Member, Bent Pin Member, and Electrode Terminal)

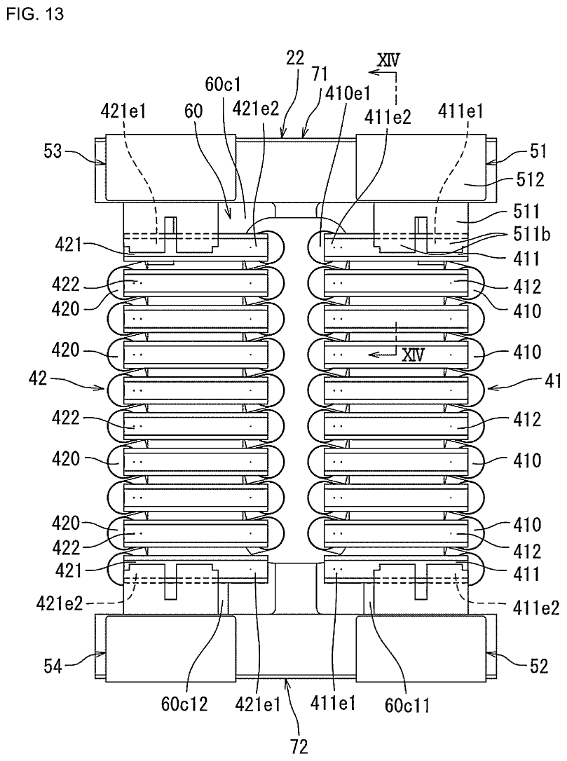

FIG. 13 is a bottom view of the coil component. In FIG. 13, the bottom plate portion and the coil adhesive member are not shown for convenience.

As shown in FIG. 13, in the first coil 41, the endmost straight pin member 411 on a first electrode terminal 51 side faces the first surface 60c1 (first region 60c11) of the bottom portion 60c. The first end portion 411e1 of the endmost straight pin member 411 is connected to the tip portion 511b of the first flat plate portion 511 of the first electrode terminal 51. The second end portion 411e2 of the endmost straight pin member 411 is connected to the first end portion 410e1 of the bent pin member 410.

Additionally, in the first coil 41, the endmost straight pin member 411 on a second electrode terminal 52 side faces the first surface 60c1 (first region 60c11) of the bottom portion 60c. The first end portion 411e1 of the endmost straight pin member 411 is not connected to the bent pin member 410 or the second electrode terminal 52. The second end portion 411e2 of the endmost straight pin member 411 is connected to the bent pin member 410 and is connected to the second electrode terminal 52.

In addition, in the second coil 42, the endmost straight pin member 421 on a third electrode terminal 53 side faces the first surface 60c1 (second region 60c12) of the bottom portion 60c. A first end portion 421e1 of the endmost straight pin member 421 is connected to the third electrode terminal 53. A second end portion 421e2 of the endmost straight pin member 421 is connected to the bent pin member 420.

Further, in the second coil 42, the endmost straight pin member 421 on a fourth electrode terminal 54 side faces the first surface 60c1 (second region 60c12) of the bottom portion 60c. The first end portion 421e1 of the endmost straight pin member 421 is not connected to the bent pin member 420 or the fourth electrode terminal 54. The second end portion 421e2 of the endmost straight pin member 421 is connected to the bent pin member 420 and is connected to the fourth electrode terminal 54.

### (Connection Relationship Between Attachment Base Portion and Electrode Terminal)

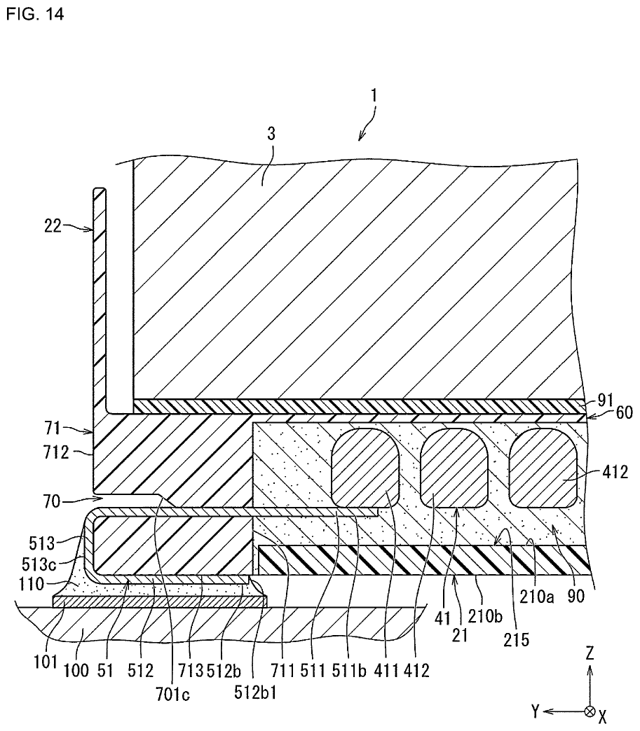

FIG. 14 is a sectional view taken along line XIV-XIV of FIG. 13. In FIG. 14, the bottom plate portion and the coil adhesive member, which are not shown in FIG. 13, are shown. Hereinafter, a connection relationship between the first electrode terminal 51 and the first attachment base portion 71 will be described. Since a connection relationship between the second electrode terminal 52 and the second attachment base portion 72, a connection relationship between the third electrode terminal 53 and the first attachment base portion 71, and a connection relationship between the fourth electrode terminal 54 and the second attachment base portion 72 are the same as the connection relationship between the first electrode terminal 51 and the first attachment base portion 71, the detailed description thereof will be omitted.

As shown in FIG. 14, the first electrode terminal 51 is attached to the first attachment base portion 71 and is connected to the end portion of the first coil 41. Specifically, the first flat plate portion 511 is inserted into the slit hole 70, the coupling portion 513 faces the outer end face 712, the second flat plate portion 512 faces the bottom surface 713, and the first flat plate portion 511 is connected to the end portion of the endmost straight pin member 411 of the first coil 41.

According to the above-described configuration, since the first flat plate portion 511 of the first electrode terminal 51 is inserted into the slit hole 70 of the first attachment base portion 71, the first electrode terminal 51 is inserted into and attached to the first attachment base portion 71. Consequently, the first electrode terminal 51 can be reliably fixed to the first attachment base portion 71, and when the coil component 1 is mounted on the mounting substrate 100, the detachment of the first electrode terminal 51 from the first attachment base portion 71 can be reduced even in a case where vibrations or impacts are applied to the coil component 1. In particular, even as the current increases, the core 3 becomes larger, the weight of the coil component 1 becomes greater, and vibrations or impacts become more significant, the detachment of the first electrode terminal 51 from the first attachment base portion 71 can be reduced.

Additionally, since the second flat plate portion 512 of the first electrode terminal 51 faces the bottom surface 713 of the first attachment base portion 71, when the coil component 1 is mounted on the mounting substrate 100, the second flat plate portion 512 can be connected to a mounting substrate 100 with solder 110 interposed therebetween. Specifically, the first electrode terminal 51 is connected to a pad portion 101 of the mounting substrate 100 with the solder 110 interposed therebetween.

As shown in FIG. 14, an outer surface 513c of the coupling portion 513 on a side opposite to the outer end face 712 includes a fillet forming region on which the solder 110 spreads upward. With this configuration, when the coil component 1 is mounted on the mounting substrate 100, the solder 110 wets the fillet forming region of the coupling portion 513, so that the mounting strength of the coil component 1 with respect to the mounting substrate 100 can be improved. In addition, when the coil component 1 is mounted on the mounting substrate 100, vibrations or impacts applied to the coil component 1 may cause stress on the coupling portion 513. However, since the solder 110 wets the fillet forming region of the coupling portion 513, the stress can be reduced by the solder 110. Further, since the coupling portion 513 faces the outer end face 712, the solder 110 can be confirmed from the outside.

As shown in FIG. 14, an end face 512b1 of the tip portion 512b of the second flat plate portion 512 includes a fillet forming region on which the solder 110 spreads upward. With this configuration, when the coil component 1 is mounted on the mounting substrate 100, the solder 110 wets the fillet forming region of the second flat plate portion 512, so that the mounting strength of the coil component 1 with respect to the mounting substrate 100 can be improved.

As shown in FIG. 14, the tip portion 511b of the first flat plate portion 511 protrudes from the inner end face 711 and is connected to the end portion of the first coil 41. Specifically, the tip portion 511b protrudes from the inner end face 711 toward a second attachment base portion 72 side. The endmost straight pin member 411 of the first coil 41 is placed on an upper surface of the tip portion 511b of the first flat plate portion 511. The upper surface of the tip portion 511b of the first flat plate portion 511 is a surface of the tip portion 511b on a side opposite to a surface on a second flat plate portion 512 side.

With this configuration, since the tip portion 511b of the first flat plate portion 511 protrudes from the inner end face 711, the end portion of the first coil 41 can be easily connected. Additionally, since the tip portion 511b of the first flat plate portion 511 is connected to the end portion of the first coil 41, for example, in a case where the end portion of the first coil 41 is connected to the tip portion 511b of the first flat plate portion 511 by welding, the heat of welding is transmitted sequentially to the first flat plate portion 511 and the coupling portion 513. Therefore, the heat of welding is less likely to be transmitted to the second flat plate portion 512, and discoloration or modification of the plating layer, such as Ni or Sn, on the second flat plate portion 512 can be reduced, thereby ensuring mounting reliability.

As shown in FIG. 14, a connection part between the first flat plate portion 511 and the end portion of the first coil 41 is covered with the coil adhesive member 90 made of a resin. The coil adhesive member 90 is present in a recess portion 215 of the bottom plate portion 21, that is, in a space surrounded by the bottom plate portion 21, the core cover portion 60, the first attachment base portion 71, and the second attachment base portion 72. With this configuration, the fixation and insulation of the connection part between the first flat plate portion 511 and the end portion of the first coil 41 can be reliably ensured by the coil adhesive member 90. In addition, since the first flat plate portion 511 is fixed to the coil adhesive member 90, the first electrode terminal 51 can be prevented from slipping out of the slit hole 70 of the first attachment base portion 71.

### (Manufacturing Method of Coil Component)

Next, a manufacturing method of the coil component 1 will be described.

With reference to FIG. 4, the annular core 3 is housed in the core cover portion 60 of the base case 22 such that the first end face 301 positioned in the central axis direction of the core 3 is covered. The core 3 is bonded to the core cover portion 60 by the core adhesive member 91.

Then, with reference to FIG. 13, the plurality of straight pin members 411, 412, 421, and 422 and the plurality of bent pin members 410 and 420 are disposed around the core 3 and the core cover portion 60 such that the end portions of the straight pin members 411, 412, 421, and 422 and the end portions of the bent pin members 410 and 420 are positioned on a first surface 60c1 side of the core cover portion 60.

Specifically, the straight pin members 411 and 412 and the bent pin members 410 of the first coil 41 are wound around the core 3 fitted into the core cover portion 60, the straight pin members 421 and 422 and the bent pin members 420 of the second coil 42 are wound around the core 3, and the winding axes of the first coil 41 and the second coil 42 are disposed to run parallel to each other. In this case, the straight pin members 411 and 412 and the end portions of the bent pin members 410 of the first coil 41, and the straight pin members 421 and 422 and the end portions of the bent pin members 420 of the second coil 42 are disposed on the first surface 60c1 side of the core cover portion 60.

Then, the end portions of the straight pin members 411, 412, 421, and 422 are connected to the end portions of the bent pin members 410 and 420 to form the coils 41 and 42 in which the straight pin members 411, 412, 421, and 422 and the bent pin members 410 and 420 are alternately connected.

Specifically, the end portions of the straight pin members 411 and 412 and the end portions of the bent pin members 410 are connected to form the first coil 41. The end portions of the straight pin members 421 and 422 and the end portions of the bent pin members 420 are connected to form the second coil 42.

In addition, the first electrode terminal 51 and the third electrode terminal 53 are inserted into respective two slit portions 70 of the first attachment base portion 71 of the base case 22 from the outer end face 712 side toward the inner end face 711 side. The second electrode terminal 52 and the fourth electrode terminal 54 are inserted into respective two slit portions 70 of the second attachment base portion 72 of the base case 22 from the outer end face 722 side toward the inner end face 721 side.

Then, the first to fourth electrode terminals 51 to 54 are connected to the endmost straight pin members 411 and 421, and the electrode terminals 51 to 54 are connected to the coils 41 and 42. Specifically, the first electrode terminal 51 and the second electrode terminal 52 are connected to the first coil 41. The third electrode terminal 53 and the fourth electrode terminal 54 are connected to the second coil 42.

After that, the bottom plate portion 21 is attached to the base case 22, and the coil component 1 is manufactured. Specifically, the bottom plate portion 21 is attached to the first surface 60c1 side of the core cover portion 60. The bottom plate portion 21 is bonded to the coils 41 and 42 and the base case 22 by the coil adhesive member 90.

### Second Embodiment

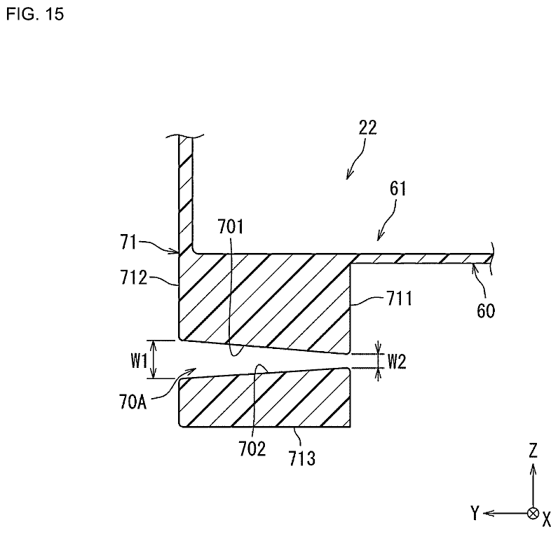

FIG. 15 is a sectional view showing a coil component of a second embodiment. In the second embodiment, the shape of the slit hole differs from that in the first embodiment (FIG. 12). This differing configuration will be described below. The other configurations are the same as those in the first embodiment, and the same reference numerals as those in the first embodiment will be assigned, and the description thereof will be omitted.

FIG. 15 is a sectional view of a part of the base case 22 including a slit hole 70A of the first attachment base portion 71. Hereinafter, the slit hole 70A of the first attachment base portion 71 will be described. The configuration of the slit hole of the second attachment base portion 72 may be the same as the configuration of the slit hole 70A of the first attachment base portion 71, and the detailed description thereof will be omitted.

As shown in FIG. 15, the slit hole 70A is an elongated hole extending in the X direction as viewed in a direction orthogonal to the inner end face 711 or the outer end face 712, similar to the configuration of the slit hole 70 of the first embodiment. That is, the long side direction of the slit hole 70A is the X direction which is the extension direction of the slit hole 70A, and the short side direction of the slit hole 70A is the Z direction which is a direction orthogonal to the extension direction of the slit hole 70A.

Similar to the configuration of the slit hole 70 of the first embodiment, the opening dimension W1 of the slit hole 70A on the outer end face 712 side in the short side direction is larger than the opening dimension W2 of the slit hole 70A on the inner end face 711 side in the short side direction. Preferably, in a state before the first flat plate portion 511 is inserted into the slit hole 70, that is, in a state in which the first flat plate portion 511 is separated from the slit hole 70, the opening dimension W2 of the slit hole 70A on the inner end face 711 side is smaller than the thickness of the first flat plate portion 511 of the first electrode terminal 51.

The dimension of the slit hole 70A in the short side direction continuously decreases from the outer end face 712 toward the inner end face 711. With this configuration, the positioning accuracy of the first electrode terminal 51 with respect to the first attachment base portion 71 is further enhanced in the fixation of the first electrode terminal 51 to the first attachment base portion 71. In a state in which the first flat plate portion 511 is inserted into the slit hole 70, the dimension of the slit hole 70A in the short side direction continuously decreases from the outer end face 712 toward the inner end face 711. However, in a state before the first flat plate portion 511 is inserted into the slit hole 70, that is, in a state in which the first flat plate portion 511 is separated from the slit hole 70, the dimension of the slit hole 70A in the short side direction may continuously decrease from the outer end face 712 toward the inner end face 711.

Specifically, in a cross-section (YZ cross-section) including the short side direction (Z direction) of the slit hole 70 and the penetration direction (Y direction) of the slit hole 70, the inner surface of the slit hole 70 includes the first inner surface 701 on the upper side in the Z direction and the second inner surface 702 on the lower side in the Z direction. The first inner surface 701 and the second inner surface 702 are each a flat surface. The first inner surface 701 and the second inner surface 702 are each inclined at an angle smaller than 90° with respect to the penetration direction (Y direction) of the slit hole 70. The first inner surface 701 and the second inner surface 702 are inclined with respect to the Y direction to approach each other from the outer end face 712 toward the inner end face 711.

### Other Embodiments

The present disclosure is not limited to the above-mentioned embodiments and can be modified in design within a scope that does not deviate from the gist of the present disclosure. For example, the respective feature points of the first and second embodiments may be combined in various ways.

The coil component need only include at least the core, the coil, the electrode terminal, and the attachment base portion, the attachment base portion need only include the slit hole, the electrode terminal need only include the first flat plate portion, the second flat plate portion, and the coupling portion, the first flat plate portion need only be inserted into the slit hole, the coupling portion need only face the outer end face, the second flat plate portion need only face the bottom surface, and the first flat plate portion need only be connected to the end portion of the coil.

The core cover portion and the attachment base portion are integrated, but may be separate bodies, and the core cover portion and the attachment base portion may be spaced apart from each other. Alternatively, the core cover portion may be omitted. Alternatively, the attachment base portion may be integrated with the bottom plate portion.

The shape of the inner surface of the slit hole may be any shape as long as the opening dimension of the slit hole on the outer end face side in the short side direction is larger than the opening dimension of the slit hole on the inner end face side in the short side direction. Alternatively, the opening dimension of the slit hole on the outer end face side in the short side direction may be smaller than or the same as the opening dimension of the slit hole on the inner end face side in the short side direction.

One turn of the coil is composed of one straight pin member and one bent pin member, but may be composed of one bent pin member. In this case, the length of the bent pin member is substantially the same as the length of one circumference of the outer periphery of the core passing through the first end face, the second end face, the inner peripheral surface, and the outer peripheral surface of the core. Additionally, one turn of the coil may be composed of a plurality of straight pin members.

The shape of the case and the shape of the core are not limited to those in the first embodiment and can be modified in design. In addition, the number of coils is not limited to that in the first embodiment and can be modified in design. Further, the number of electrode terminals is not limited to that in the first embodiment and can be modified in design.

The present disclosure includes the following aspects.

<1> A coil component including a core having an annular shape; a coil wound around the core; an electrode terminal connected to the coil; and an attachment base portion to which the electrode terminal is attached. The attachment base portion includes an inner end face facing a core side, an outer end face facing a side opposite to the inner end face, a bottom surface coupling the inner end face and the outer end face to each other, and a top surface facing a side opposite to the bottom surface, and the attachment base portion includes a slit hole penetrating between the inner end face and the outer end face. The electrode terminal includes a first flat plate portion, a second flat plate portion, and a coupling portion coupling the first flat plate portion and the second flat plate portion to each other, and the first flat plate portion and the second flat plate portion face each other. The first flat plate portion is inserted into the slit hole, the coupling portion faces the outer end face, the second flat plate portion faces the bottom surface, and the first flat plate portion is connected to an end portion of the coil.

<2> The coil component according to <1>, in which the core is an oval annular body as viewed in a central axis direction, the attachment base portion includes a first attachment base portion and a second attachment base portion, and the first attachment base portion and the second attachment base portion are positioned on respective sides of the core with the core in between in a major axis direction of the core as viewed in the central axis direction.

<3> The coil component according to <2>, in which the slit hole includes a plurality of slit holes included in the first attachment base portion and a plurality of slit holes included in the second attachment base portion.

<4> The coil component according to any one of <1> to <3>, in which an outer surface of the coupling portion on a side opposite to the outer end face includes a fillet forming region on which solder spreads upward.

<5> The coil component according to any one of <1> to <4>, in which an end face of a tip portion of the second flat plate portion on a side opposite to the coupling portion includes a fillet forming region on which solder spreads upward.

<6> The coil component according to any one of <1> to <5>, in which a tip portion of the first flat plate portion on a side opposite to the coupling portion protrudes from the inner end face and is connected to the end portion of the coil.

<7> The coil component according to any one of <1> to <6>, in which a connection part between the first flat plate portion and the end portion of the coil is covered with an adhesive member made of a resin.

<8> The coil component according to any one of <1> to <7>, in which an opening dimension of the slit hole on an outer end face side in a short side direction is larger than an opening dimension of the slit hole on an inner end face side in the short side direction.

<9> The coil component according to <8>, in which the first flat plate portion is press-fitted into an opening of the slit hole on at least the inner end face side.

<10> The coil component according to <8> or <9>, in which a dimension of the slit hole in the short side direction continuously decreases from the outer end face toward the inner end face.

<11> The coil component according to <8> or <9>, in which an inner surface of the slit hole includes a stepped surface where a dimension of the slit hole in the short side direction decreases stepwise from the outer end face toward the inner end face.

<12> The coil component according to <11>, in which the stepped surface is an inclined surface where the dimension of the slit hole in the short side direction continuously decreases from the outer end face toward the inner end face.

What is claimed is:

1. A coil component comprising:
a core having an annular shape;
a coil wound around the core;
an electrode terminal connected to the coil; and
an attachment base portion to which the electrode terminal is attached, wherein
the attachment base portion includes an inner end face facing a core side, an outer end face facing a side opposite to the inner end face, a bottom surface coupling the inner end face and the outer end face to each other, and a top surface facing a side opposite to the bottom surface, and the attachment base portion includes a slit hole penetrating between the inner end face and the outer end face,
the electrode terminal includes a first flat plate portion, a second flat plate portion, and a coupling portion coupling the first flat plate portion and the second flat plate portion to each other, and the first flat plate portion and the second flat plate portion face each other, and
the first flat plate portion extends into the slit hole, the coupling portion faces the outer end face, the second flat plate portion faces the bottom surface, and the first flat plate portion is connected to an end portion of the coil.

2. The coil component according to claim 1, wherein
the core is an oval annular body as viewed in a central axis direction,
the attachment base portion includes a first attachment base portion and a second attachment base portion, and
the first attachment base portion and the second attachment base portion are on respective sides of the core with the core in between in a major axis direction of the core as viewed in the central axis direction.

3. The coil component according to claim 2, wherein
the slit hole includes a plurality of slit holes included in the first attachment base portion and a plurality of slit holes included in the second attachment base portion.

4. The coil component according to claim 1, wherein
an outer surface of the coupling portion on a side opposite to the outer end face includes a fillet forming region on which solder spreads upward.

5. The coil component according to claim 1, wherein
an end face of a tip portion of the second flat plate portion on a side opposite to the coupling portion includes a fillet forming region on which solder spreads upward.

6. The coil component according to claim 1, wherein
a tip portion of the first flat plate portion on a side opposite to the coupling portion protrudes from the inner end face and is connected to the end portion of the coil.

7. The coil component according to claim 1, wherein
a connection part between the first flat plate portion and the end portion of the coil is covered with an adhesive member including a resin.

8. The coil component according to claim 1, wherein
an opening dimension of the slit hole on an outer end face side in a short side direction is larger than an opening dimension of the slit hole on an inner end face side in the short side direction.

9. The coil component according to claim 8, wherein
the first flat plate portion is press-fitted into an opening of the slit hole on at least the inner end face side.

10. The coil component according to claim 8, wherein
a dimension of the slit hole in the short side direction continuously decreases from the outer end face toward the inner end face.

11. The coil component according to claim 8, wherein
an inner surface of the slit hole includes a stepped surface where a dimension of the slit hole in the short side direction decreases stepwise from the outer end face toward the inner end face.

12. The coil component according to claim 11, wherein
the stepped surface is an inclined surface where the dimension of the slit hole in the short side direction continuously decreases from the outer end face toward the inner end face.

13. The coil component according to claim 2, wherein
an outer surface of the coupling portion on a side opposite to the outer end face includes a fillet forming region on which solder spreads upward.

14. The coil component according to claim 3, wherein
an outer surface of the coupling portion on a side opposite to the outer end face includes a fillet forming region on which solder spreads upward.

15. The coil component according to claim 2, wherein
an end face of a tip portion of the second flat plate portion on a side opposite to the coupling portion includes a fillet forming region on which solder spreads upward.

16. The coil component according to claim 2, wherein
a tip portion of the first flat plate portion on a side opposite to the coupling portion protrudes from the inner end face and is connected to the end portion of the coil.

17. The coil component according to claim 2, wherein
a connection part between the first flat plate portion and the end portion of the coil is covered with an adhesive member including a resin.

18. The coil component according to claim 2, wherein
an opening dimension of the slit hole on an outer end face side in a short side direction is larger than an opening dimension of the slit hole on an inner end face side in the short side direction.

19. The coil component according to claim 9, wherein
a dimension of the slit hole in the short side direction continuously decreases from the outer end face toward the inner end face.

20. The coil component according to claim 9, wherein
an inner surface of the slit hole includes a stepped surface where a dimension of the slit hole in the short side direction decreases stepwise from the outer end face toward the inner end face.
